(19) United States
(12) Patent Application Publication
(10) Pub. No.: US 2017/0046026 A1
(43) Pub. Date: Feb. 16, 2017

(54) MEDICAL IMAGE CAPTURE APPARATUS, AND PROGRAM FOR CONTROLLING THE SAME

(71) Applicant: GE MEDICAL SYSTEMS GLOBAL TECHNOLOGY COMPANY, LLC, Waukesha, WI (US)

(72) Inventors: Ryoichi Tokuda, Hino-Shi (JP); Konstantina Mertika, Marousi (GR); Eun Jin Lee, Seongnam (KR)

(73) Assignee: GE Medical Systems Global Technology Company, LLC, Waukesha, WI (US)

(21) Appl. No.: 15/305,446

(22) PCT Filed: Apr. 17, 2015
(86) PCT No.: PCT/US2015/026425

§ 371 Date: Oct. 20, 2016

(30) Foreign Application Priority Data
Apr. 21, 2014 (JP) 2014-086995

(51) Int. Cl. G06F 3/0482; G06F 19/00; G06F 3/0484

(52) U.S. Cl. CPC G06F 3/0482; G06F 3/04847; G06F 19/3406

(57) ABSTRACT

To provide a medical image capture apparatus capable of improving an operator's workflow when the operator selects operation buttons. A medical image capture apparatus is an ultrasonic diagnostic apparatus, for example, and comprises: an auxiliary display section in which operation buttons to be selected by an operator are displayed; and a processor for executing a program of an operation button display control function of displaying the operation buttons in the auxiliary display section, said function displaying a plurality of the operation buttons that each belong to one of a plurality of categories and are specified beforehand, in one window separately on a category-by-category basis. The plurality of categories are, for example, a category of measurement button Bm, a category of comment button Bc, a category of body pattern button Bb, and a category of button Bo for inputting other commands.

### CROSS-REFERENCE TO RELATED APPLICATION SECTION

This application is a filing under 35 U.S.C. 371 of international application number PCT/US2015/026425, filed Apr. 17, 2015, which claims priority to Japan application No. 2014-086995, filed Apr. 21, 2014, the entire disclosure of each of which is hereby incorporated by reference.

### BACKGROUND

The present invention relates to a medical image capture apparatus for conducting capture of medical images, and a program for controlling the same.

In medical image capture apparatuses, such as ultrasonic diagnostic apparatuses, X-ray CT (Computed Tomography) apparatuses, and MRI (Magnetic Resonance Imaging) apparatuses, operation buttons to be selected by an operator are displayed in a display section. For example, in some ultrasonic diagnostic apparatuses, an auxiliary display section using a touch screen is provided in addition to a display section in which an ultrasonic image is displayed (see Patent Document 1, for example), and the operation buttons are displayed in the auxiliary display section. An operator selects from the operation buttons for inputting a command.

The operation buttons displayed in the auxiliary display section include various categories of operation button. For example, they include measurement buttons for displaying in the display section a measurement marker for measuring a length or an area in an ultrasonic image, body pattern buttons for displaying body patterns in the display section in which the ultrasonic image is displayed, and comment buttons for displaying a comment in the display section in which the ultrasonic image is displayed.

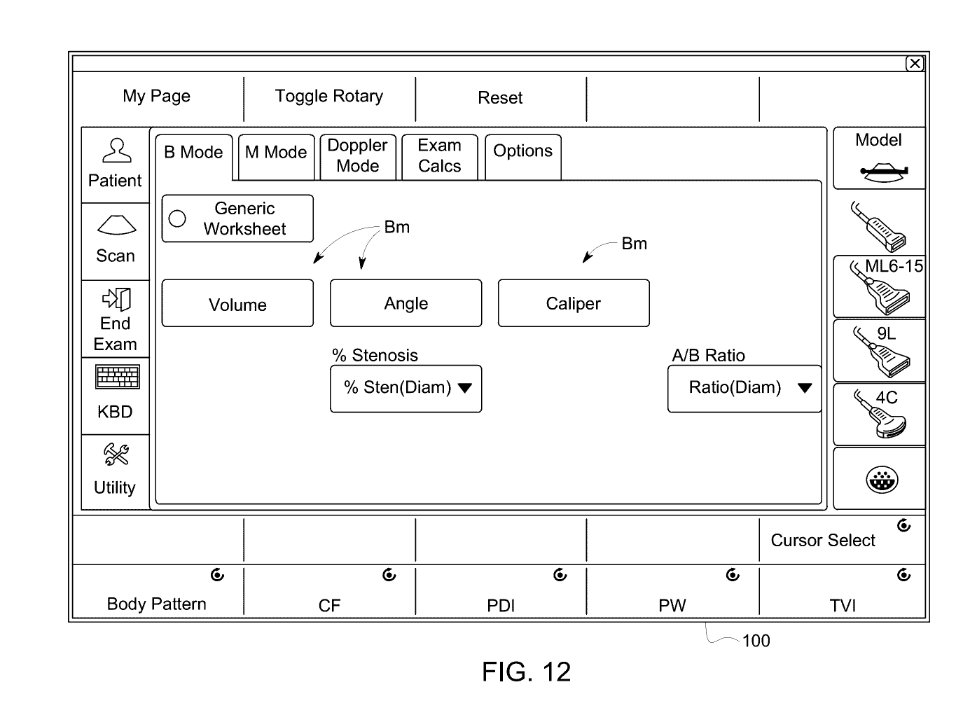

These measurement buttons, body pattern buttons, and comment buttons include various kinds of button, respectively, and they are separately displayed. For example, when an input for displaying the measurement buttons is made, several measurement buttons Bm are displayed in an auxiliary display section 100, as shown in FIG. 12. In FIG. 12, there are displayed measurement buttons Bm used while a B-mode image is displayed. When one of the measurement buttons Bm is selected by an operator, a measurement marker assigned to the selected measurement button Bm is displayed.

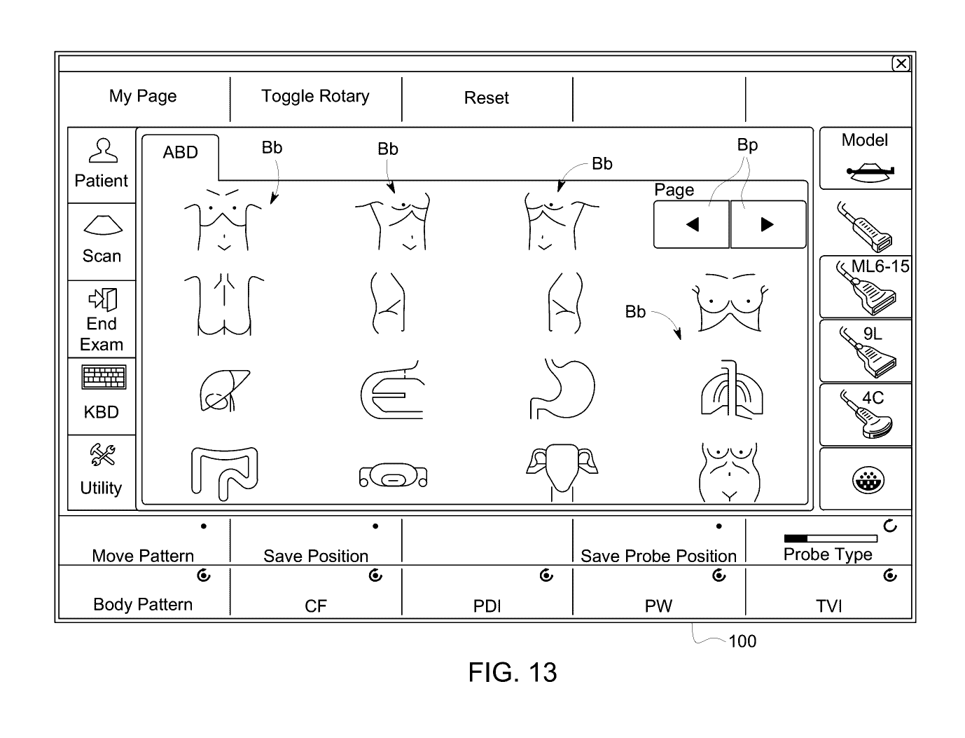

When an input for displaying the body pattern buttons is made, several body pattern buttons Bb are displayed in the auxiliary display section 100, as shown in FIG. 13. In FIG. 13, there are displayed body pattern buttons Bb used when an abdominal examination is conducted.

The number of the body pattern buttons Bb used in the abdominal examination is greater than the number of body pattern buttons Bb that can be displayed in one window. The remaining hidden body pattern buttons Bb may be displayed by an operator pressing a pagination button Bp. Once the operator has selected one of the body pattern buttons Bb, a body pattern assigned to the selected body pattern button Bb is displayed.

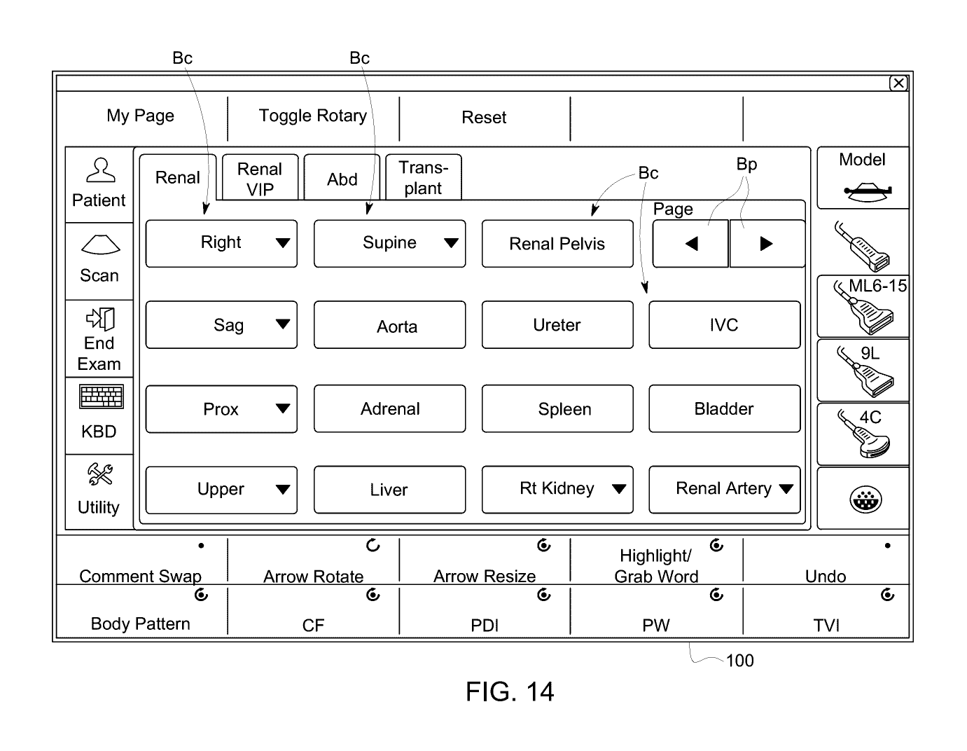

When an input for displaying the comment buttons is made, several comment buttons Bc are displayed in the auxiliary display section 100, as shown in FIG. 14. In FIG. 14, there are displayed comment buttons Bc used when a renal examination is conducted. Again in FIG. 14, the remaining hidden comment buttons Bc may be displayed by an operator pressing a pagination button Bp. Once one of the comment buttons Bc has been selected, a comment assigned to the selected comment button Bc is displayed.

### SUMMARY OF THE INVENTION

As described above, operation buttons belonging to different categories are displayed in separate windows. Thus, an input for displaying operation buttons is required for every category. For example, when an operator attempts to conduct a measurement during an examination, he/she makes an input for displaying measurement buttons. Then, when the operator desires to display a comment, he/she makes an input for displaying comment buttons. Therefore, the operator is required to make an input each time operation buttons in a different category are to be displayed. Especially, it is cumbersome for the operator to make such an input while conducting transmission/reception by an ultrasonic probe during an examination.

Moreover, since a number of operation buttons are displayed in one category, the operator must search for a desired operation button from among the displayed ones. Especially in case that operation buttons cannot be displayed in one window and are displayed across several pages, it is sometimes time-consuming to search for a desired operation button.

As can be seen from the above, it is desirable to improve an operator's workflow when he/she selects operation buttons in a medical image capture apparatus.

To solve the aforementioned problem, the inventors in the present application focus on the fact that, as for the aforementioned operation buttons, although various operation buttons are provided corresponding to various examinations, operation buttons and their categories in use are limited according to a type of examination and/or to an operator. The invention in one aspect made for solving the aforementioned problem is a medical image capture apparatus characterized in comprising: an operation button display section in which operation buttons to be selected by an operator are displayed; and a processor for executing a program of an operation button display control function of displaying said operation buttons in said operation button display section, said function displaying a plurality of said operation buttons that each belong to one of a plurality of categories and are specified beforehand, in one window separately on a category-by-category basis.

According to the invention in the aspect described above, since a plurality of the operational buttons that each belong to one of a plurality of categories and are specified beforehand are displayed in one window separately on a category-by-category basis, an operator can immediately find a required operation button, and the need to make an input for displaying operation buttons for every category may be eliminated. Thus, an operator's workflow can be improved.

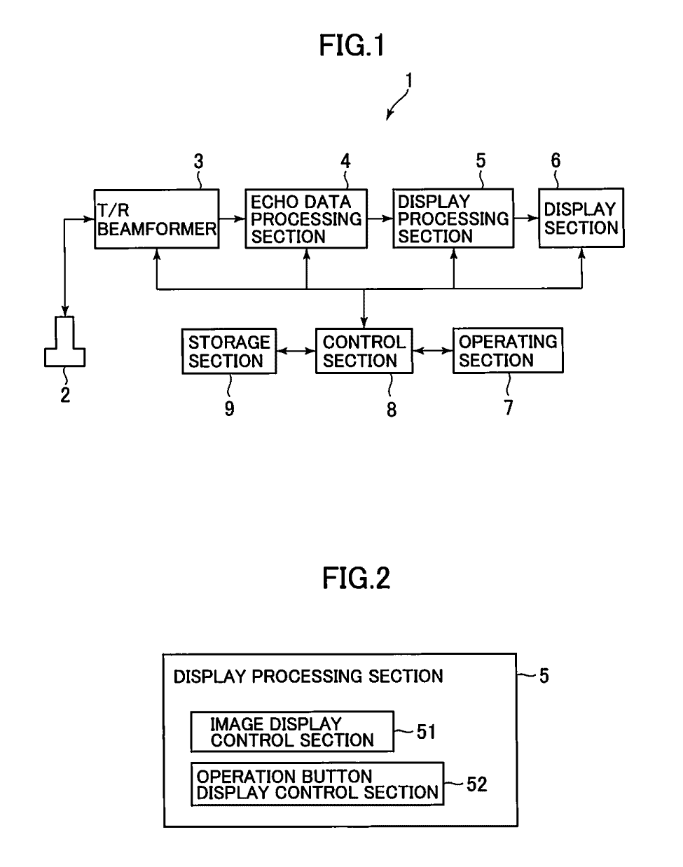

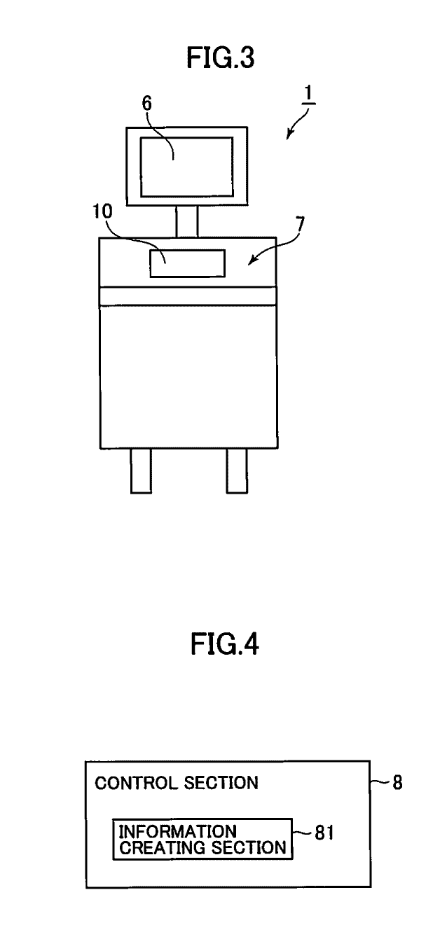

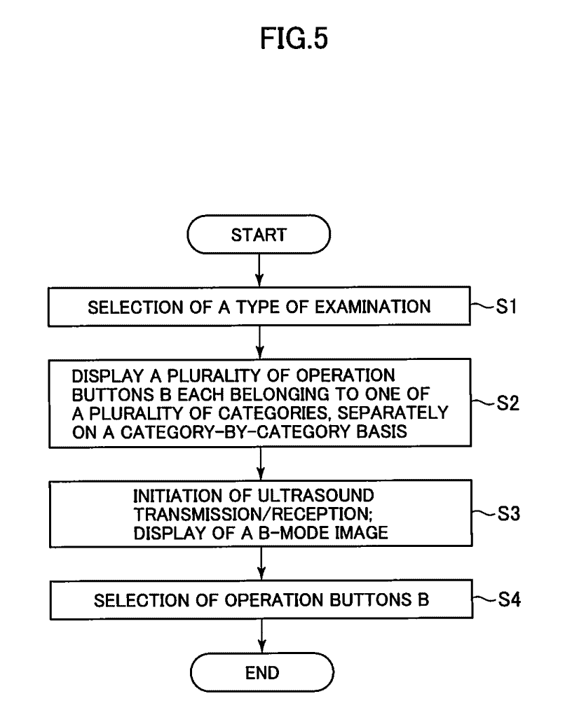

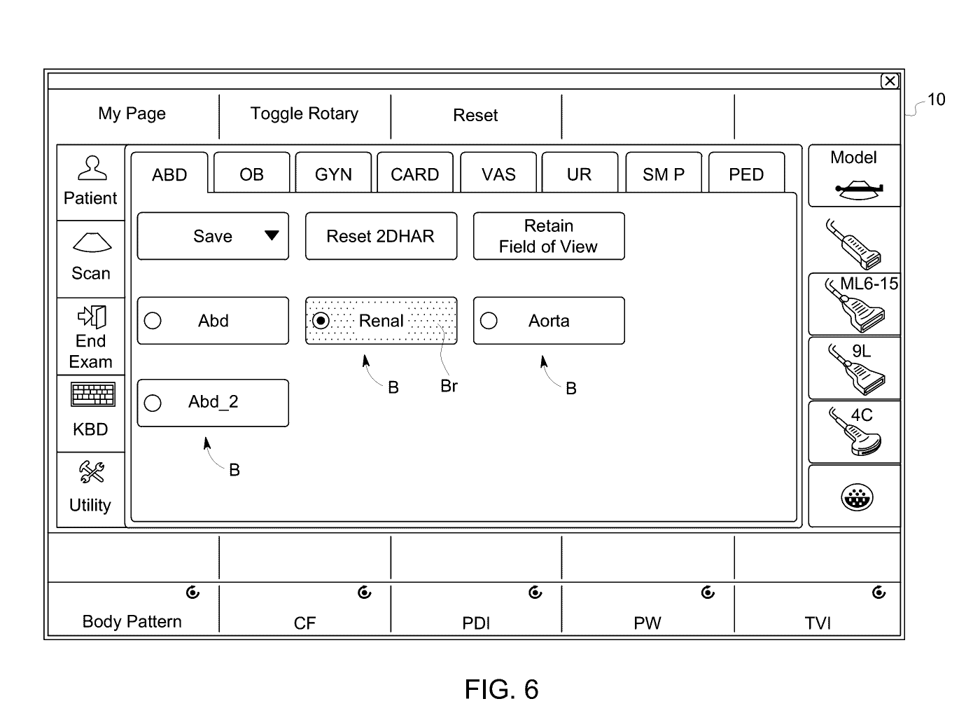

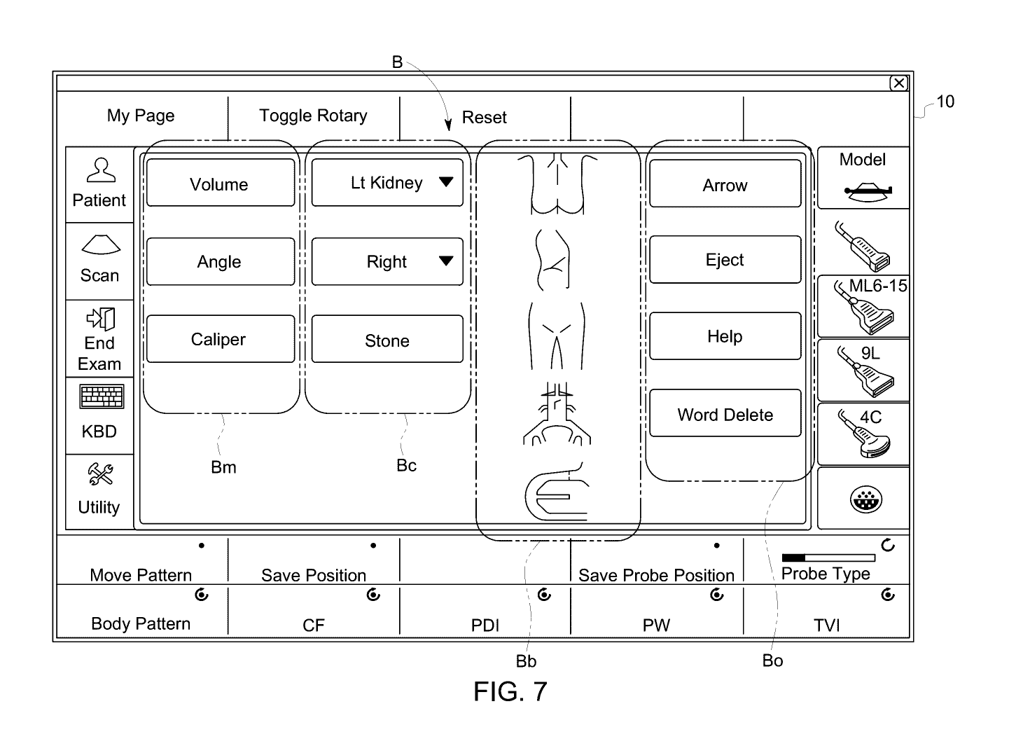

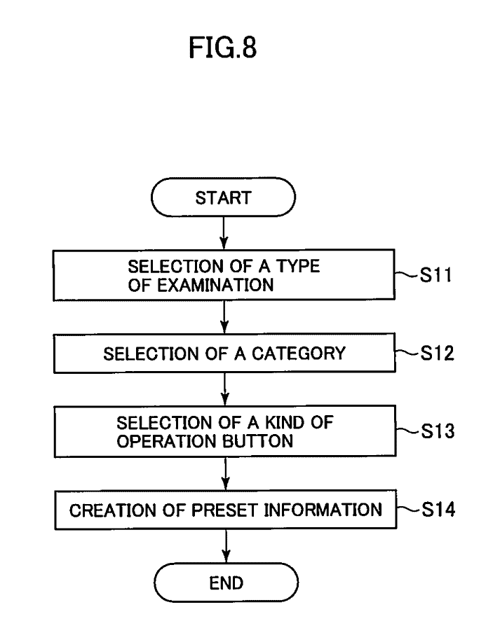

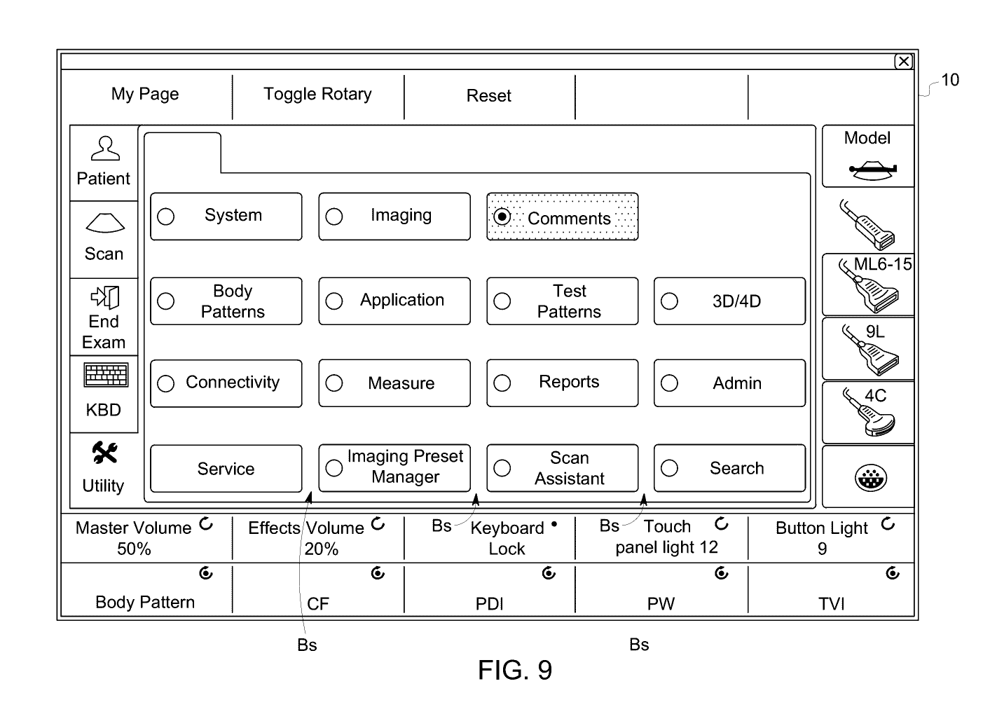

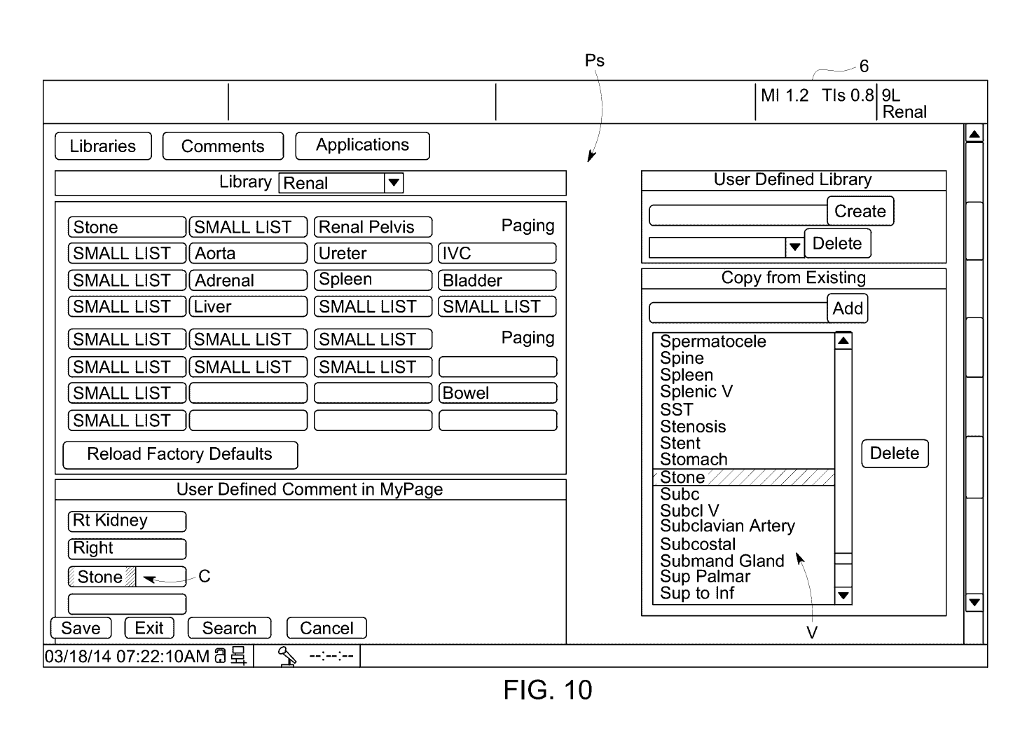

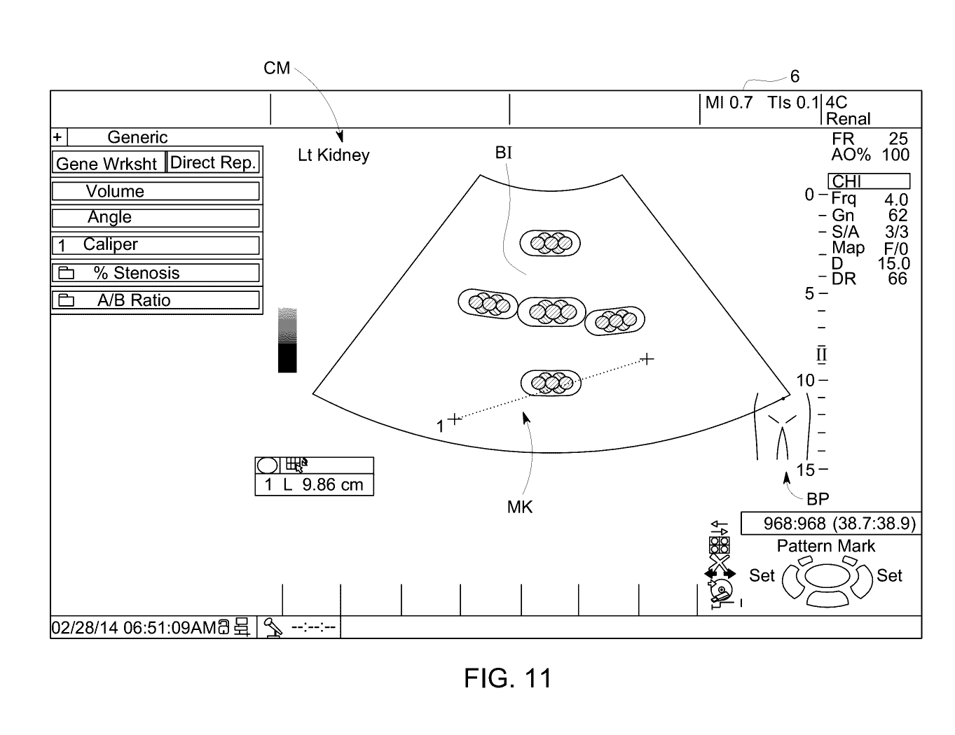

### BRIEF DESCRIPTION OF THE DRAWINGS

[FIG. 1] A block diagram showing a schematic configuration of an ultrasonic diagnostic apparatus, which is an exemplary embodiment of the present invention.

[FIG. 2] A block diagram showing a configuration of the display processing section.

[FIG. 3] A schematic representation showing an appearance of the ultrasonic diagnostic apparatus.

[FIG. 4] A block diagram showing part of functions of the control section.

[FIG. 5] A flow chart showing an operation of the ultrasonic diagnostic apparatus in the embodiment.

[FIG. 6] A diagram showing an auxiliary display section in which operation buttons for selecting a region to be examined are displayed.

[FIG. 7] A diagram showing the auxiliary display section in which a plurality of operation buttons belonging to different categories are displayed on a category-by-category basis.

[FIG. 8] A flow chart showing processing of creation of preset information.

[FIG. 9] A diagram showing the auxiliary display section in which category selection buttons are displayed.

[FIG. 10] A diagram showing the display section in which a selection image for selecting a comment button(s) is displayed.

[FIG. 11] A diagram showing the display section in which a measurement marker, a comment, and a body pattern are displayed.

[FIG. 12] A diagram showing a conventional auxiliary display section in which measurement buttons are displayed.

[FIG. 13] A diagram showing the conventional auxiliary display section in which body pattern buttons are displayed.

[FIG. 14] A diagram showing the conventional auxiliary display section in which comment buttons are displayed.

### DETAILED DESCRIPTION OF THE INVENTION

Now several embodiments of the present invention will be described below with reference to the accompanying drawings. The following description will be made referring to an ultrasonic diagnostic apparatus as an example of the medical image capture apparatus of the present invention. An ultrasonic diagnostic apparatus 1 shown in FIG. 1 comprises an ultrasonic probe 2, a transmission/reception (T/R) beamformer 3, an echo data processing section 4, a display processing section 5, a display section 6, an operating section 7, a control section 8, and a storage section 9.

The ultrasonic probe 2 is configured to have a plurality of ultrasonic transducers arranged in an array, and ultrasound is transmitted to a subject and echo signals therefrom are received by these ultrasonic transducers.

The T/R beamformer 3 drives the ultrasonic probe 2 to transmit ultrasound having predefined transmission parameters based on control signals from the control section 8. The T/R beamformer 3 also applies signal processing such as phased-addition processing to ultrasonic echo signals.

The echo data processing section 4 applies B-mode processing including, for example, logarithmic compression processing and envelope detection processing, to echo data output from the T/R beamformer 3 to create B-mode data. The echo data processing section 4 may apply other processing such as Doppler processing.

The display processing section 5 has an image display control section 51 and an operation button display control section 52, as shown in FIG. 2. The image display control section 51 scan-converts raw data obtained at the echo data processing section 4 by a scan converter to create ultrasonic image data, and displays an ultrasonic image in the display section 6 based on the ultrasonic image data. For example, the image display control section 51 scan-converts the aforementioned B-mode data by the scan converter to create B-mode image data, and displays a B-mode image in the display section 6 based on the B-mode image data. The B-mode image represents an example of the medical image.

The image display control section 51 displays images other than the ultrasonic image, such as, for example, characters and graphic symbols, in the display section 6.

The operation button display control section 52 displays operation buttons B in an auxiliary display section 10, which will be described later, provided in the operating section 7 (an operation button display control function). The operation buttons B are for an operator to input a command to the ultrasonic diagnostic apparatus 1. The operator selects from the operation buttons B for inputting a command

The operation button display control section 52 displays a plurality of the operation buttons B each belonging to one of a plurality of categories in one window separately on a category-by-category basis. Details thereof will be discussed later. The operation button display control function represents an exemplary embodiment of the operation button display control function in the present invention. The operation button display control section 52 represents an exemplary embodiment of the operation button display control section in the present invention.

The display section 6 is an LCD (Liquid Crystal Display), an organic EL (Electro-Luminescence) display, or the like.

The operating section 7 is configured to comprise a keyboard for allowing an operator to input a command and/or information, operation buttons, a pointing device such as a trackball, and the like, although not particularly shown.

The operation buttons are soft keys and hard keys. The operating section 7 is provided with the auxiliary display section 10, as shown in FIG. 3, and the operation buttons B are displayed in the auxiliary display section 10 as the soft keys. The auxiliary display section 10 is constructed from a touch screen in the present embodiment. The auxiliary display section 10 represents an exemplary embodiment of the operation button display section in the present invention. The operation buttons B as the soft keys represent an exemplary embodiment of the operation buttons in the present invention.

Operation buttons as the hard keys are omitted in the drawings.

The control section 8 is a processor such as a CPU (Central Processing Unit). The control section 8 loads thereon a program stored in the storage section 9 and controls several sections in the ultrasonic diagnostic apparatus 1. For example, the control section 8 loads thereon a program stored in the storage section 9 and executes functions of the T/R beamformer 3, echo data processing section 4, and display processing section 5 by the loaded program. The processor constituting the control section 8 represents an exemplary embodiment of the processor in the present invention.

The control section 8 may execute all of the functions of the T/R beamformer 3, all of the functions of the echo data processing section 4, and all of the functions of the display processing section 5 by the program, or execute only part of the functions by the program. In case that the control section 8 executes only part of the functions, the remaining functions may be executed by hardware such as circuitry.

It should be noted that the functions of the T/R beamformer 3, echo data processing section 4, and display processing section 5 may be implemented by hardware such as circuitry.

The control section 8 also loads thereon a program stored in the storage section 9 and executes a function of an information creating section 81 shown in FIG. 4 by the program. The information creating section 81 creates preset information including information on operation buttons B to be displayed in the auxiliary display section 10 by the operation button display control section 81 and information on categories to which the operation buttons belong (information creating function). Details thereof will be discussed later. The information creating function represents an exemplary embodiment of the information creating function in the present invention.

The storage section 9 is an HDD (Hard Disk Drive), and/or a semiconductor memory such as a RAM (Random Access Memory) and/or a ROM (Read-Only Memory). The storage section 9 represents an exemplary embodiment of the storage section in the present invention.

Next, an operation of the ultrasonic diagnostic apparatus 1 in the present embodiment will be described based on the flow chart in FIG. 5. The flow chart in FIG. 5 shows a processing flow in an examination using the ultrasonic diagnostic apparatus 1.

First, at Step S1, the operation button display control section 52 displays operation buttons B for selecting a type of examination in the auxiliary display section 10, as shown in FIG. 6. The operation button display control section 52 displays the operation buttons B based on an input by the operator at the operating section 7. The operator then selects a type of examination by the operation buttons B displayed in the auxiliary display section 10.

The type of examination herein is a region to be examined. The operation buttons B are buttons for selecting a region to be examined In the operation buttons B shown in FIG. 6, there are displayed characters representing regions to be examined. In FIG. 6, the operation button Br of “Renal” is selected, so that a kidney is selected as the region to be examined. The selected operation button Br is displayed in a color different from that of other operation buttons B (as indicated by dots in FIG. 6).

Selection from the operation buttons B displayed in the auxiliary display section 10 may be made by the operator touching an operation button B displayed in the auxiliary display section 10 by his/her finger or the like, or by using the pointing device in the operating section 7. This similarly applies to selection from the operation buttons B displayed in the auxiliary display section 10 in the following description. That is, an input at the auxiliary display section 10 in the operating section 7 may be an input by the operator touching the auxiliary display section 10 by his/her finger or the like, or an input by using the pointing device in the operating section 7.

Once a region to be examined has been selected at Step S1, the operation button display control section 52 displays a plurality of operation buttons B specified beforehand by the operator, in the auxiliary display section 10 at Step S2, as shown in FIG. 7. More particularly, the operation button display control section 52 displays the plurality of operation buttons B each belonging to one of a plurality of categories in one window separately on a category-by-category basis.

In the present embodiment, a plurality of operation buttons B each belonging to one of four categories are displayed. A first category is for measurement buttons Bm for displaying in the display section 6 a measurement marker MK (see FIG. 11) for measuring a length or a volume in an ultrasonic image displayed in the display section 6, and a second category is for comment buttons Bc for displaying a comment CM (see FIG. 11) in the display section 6. A third category is for body pattern buttons Bb for displaying a body pattern BP (see FIG. 11) in the display section 6, and a fourth category is for buttons Bo for inputting other commands It should be noted that a long dashed double dotted line surrounding each of the categories in FIG. 7 is drawn for convenience of explanation.

The operation buttons B belonging to the same category (the measurement buttons Bm, comment buttons Bc, body pattern buttons Bb, and buttons Bo) are arranged in a vertical direction. Different categories are arranged in a horizontal direction orthogonal to the direction of arrangement of the operation buttons B belonging to the same category.

The operation buttons B displayed at Step S2 are those to be selected by the operator for him/herself to input a command during capture of an ultrasonic image such as a B-mode image. In the present embodiment, the operation buttons B are buttons for displaying graphic symbols such as the measurement marker MK and/or body pattern BP, characters such as the comment CM, and the like, in a B-mode image displayed in the display section 6 during capture of the B-mode image.

At Step S2, the operation button display control section 52 displays the measurement buttons Bm, comment buttons Bc, body pattern buttons Bb, and buttons Bo based on preset information P stored in the storage section 9. The preset information P includes information on operation buttons B to be displayed in one window of the auxiliary display section 10, and information on categories to which the operation buttons B belong. The operation buttons B and the categories to which the operation buttons B belong in the preset information P are operation buttons and categories specified by the operator. The preset information P is created by the information creating section 81 for each type of examination conducted in the ultrasonic diagnostic apparatus 1, and stored in the storage section 9. Once information for specifying a type of examination, operation buttons B, and categories is input by the operator at the operating section 7, the information creating section 81 creates the preset information P based on the input. The type of examination refers to a region to be examined and a purpose of the examination.

The preset information P here is information created and stored regarding a renal examination, and is information on the measurement buttons Bm, comment buttons Bc, body pattern buttons Bb, and buttons Bo specified by the operator.

Now creation of the preset information P will be described below. Creation of the preset information P is conducted before an examination (before the processing at Steps S1 through S4 in FIG. 5 is conducted). The preset information P is created according to an input by the operator. The operator who makes an input for creating the preset information P may be an examiner who conducts an examination using the ultrasonic diagnostic apparatus 1. Alternatively, the operator who makes an input for creating the preset information P may be a person other than the examiner. The person other than the examiner may be, for example, a person who installs the ultrasonic diagnostic apparatus 1 in an institution such as a hospital or a person who makes an input when the apparatus is shipped from the factory.

Now creation of the preset information P will be particularly described based on the flow chart in FIG. 8. First, at Step S11, the operator makes an input for selecting a renal examination as a type of examination (see FIG. 6). Next, at Step S12, the operation button display control section 52 displays category selection buttons Bs for selecting a category in the auxiliary display section 10, as shown in FIG. 9. The operation button display control section 52 displays the category selection buttons Bs based on an input by the operator at the operating section 7. Once the category selection buttons Bs have been displayed, the operator makes an input for selecting a category selection button Bs of a desired category at the operating section 7. In FIG. 9, a category selection button Bs for selecting a category of “Comments” is selected.

Categories corresponding to the category selection buttons Bs are stored in the storage section 9. The storage section 9 stores therein categories of operation button B likely to be used in the ultrasonic diagnostic apparatus 1 corresponding to various examinations.

Next, at Step S13, the operator selects kinds of operation button B in the category selected at Step S12. Here, kinds of comment button Bc are selected. In particular, when a category of “Comments” is selected at Step S12, the image display control section 51 displays a selection window Ps for selecting kinds of comment button Bc in the display section 6 at Step S13, as shown in FIG. 10. The selection window Ps has a comment list V in which kinds of comment button Bc are listed. The operator makes an input for selecting a desired kind of comment button Bc in the comment list V at the operating section 7. The selected kinds of comment button Bc are displayed in a selected button display field C. The operator selects comment buttons Bc likely to be used by an operator of the ultrasonic diagnostic apparatus 1 in the renal examination.

Kinds of operation button B such as the comment buttons Bc described above are stored in the storage section 9. The storage section 9 stores therein operation buttons B likely to be used in the ultrasonic diagnostic apparatus 1 corresponding to various examinations.

Once kinds of comment button Bc have been selected at Step S13, the preset information creating section 81 creates preset information P containing the category of comment button Bc selected at Step S12 and the kinds of comment button Bc selected at Step S13 as preset information P for the renal examination at Step S14. The created preset information P is stored in the storage section 9.

Similarly to the above, the preset information P is created and stored for the category of measurement button Bm, category of body pattern button Bb, and category of button Bo for inputting other commands.

Kinds and categories of operation button in the preset information P stored in the storage section 9 may be added and deleted. In particular, the operator can add kinds and categories of operation button by making an input for selecting a type of examination, selecting a category, and selecting a kind of operation button B at the operating section 7, similarly to Steps S11 through S13 described above. The operator can also make an input for deleting a category and a kind of operation button B in the preset information P at the operating section 7, although not particularly shown. Once a kind and/or category of operation button B has been added or deleted by an input at the operating section 7, the information creating section 81 updates items in the preset information P. The updated preset information P is stored in the storage section 9.

For types of examination other than that for a kidney, preset information including information on operation buttons B to be displayed in one window and categories to which the operation buttons B belong is created and stored in the storage section 9 in a similar way to that for the preset information P for the renal examination. Therefore, the preset information P stored in the storage section 9 includes information for identifying a type of examination so as to distinguish which type of examination the preset information is related to.

Now return to the description of the flow chart in FIG. 5. When the measurement buttons Bm, comment buttons Bc, body pattern buttons Bb, and buttons Bo are displayed at Step S2 described above, the operator initiates ultrasound transmission/reception by the ultrasonic probe 2 at Step S3. Thus, a B-mode image is displayed in the display section 6.

Next, at Step S4, the operator makes an input at the operating section 7 for selecting required operation buttons B from the measurement buttons Bm, comment buttons Bc, body pattern buttons Bb, and buttons Bo displayed at Step S2. For example, when an input is made at the operating section 7 for selecting a “Caliper” button from the measurement buttons Bm, the image display control section 51 displays a measurement marker MK for measuring a distance between two points over a B-mode image BI displayed in the display section 6, as shown in FIG. 11. Moreover, when an input is made at the operating section 7 for selecting a “Lt Kidney” button from the comment buttons Bc, the image display control section 51 displays a comment CM comprised of characters “Lt Kidney” in the display section 6. Further, the image display control section 51 displays a body pattern BP selected from among the body pattern buttons Bb in the display section 6.

According to the present embodiment, while the operation buttons B are provided as various operation buttons corresponding to various examinations, those likely to be used by the operator in a certain examination at the ultrasonic diagnostic apparatus 1 are specified by the operator, and are stored as the preset information P. The operation buttons B stored as the preset information P are then displayed in one window separately on a category-by-category basis, so that the operator can immediately find a required operation button B during an examination, and the need to make an input for displaying operation buttons B for every category is eliminated. Thus, an operator's workflow can be improved.

Especially in the ultrasonic diagnostic apparatus 1, the operator conducts ultrasound transmission/reception while holding the ultrasonic probe 2 in his/her hand during capture of a B-mode image. According to the present embodiment, since operation buttons B to be selected by the operator during image capture are displayed as described above, the operator can easily select operation buttons B even during image capture.

While the present invention has been described with reference to the embodiments, it will be easily recognized that the present invention may be practiced with several modifications without departing from the spirit and scope thereof. For example, the preset information may be created for each operator. The preset information may also be created for each imaging mode in ultrasonic imaging. The imaging mode refers to a B-mode, a Doppler mode, and the like. Moreover, the preset information may be created for each type of ultrasonic probe 2.

Further, the preset information may be created for each combination of two or more of the type of examination, operator, imaging mode, and type of ultrasonic probe 2. For example, the preset information may be created for each type of examination, and for each operator as well.]

Furthermore, the present invention is not limited to ultrasonic diagnostic apparatuses, and may be likewise applied to any medical image capture apparatus for capturing a medical image of a subject, such as, for example, X-ray CT (Computed Tomography) apparatuses, and MRI (Magnetic Resonance Imaging) apparatuses.

1. A medical image capture apparatus comprising:
an operation button display section in which a plurality of operation buttons to be selected by an operator are displayed; and
a processor for executing a program of an operation button display control function of displaying said plurality of operation buttons in said operation button display section, said function displaying said plurality of operation buttons that each belong to one of a plurality of categories and are specified beforehand, in one window separately on a category-by-category basis.

2. The medical image capture apparatus as recited in claim 1, characterized in that:
said processor executes a program of an information creating function of creating preset information including information on said operation buttons displayed in said one window and information on categories to which said operation buttons belong, said function creating said preset information based on an input by the operator specifying said operation buttons and categories to which said operation buttons belong, and
said operation button display control function displays said operation buttons based on said preset information.

3. The medical image capture apparatus as recited in claim 2, comprising: a storage section for storing therein said preset information.

4. The medical image capture apparatus as recited in claim 3, characterized in that: said information creating function updates said preset information based on an input by the operator for adding or deleting said category or said operation button in said preset information stored in said storage section.

5. The medical image capture apparatus as recited in any one of claim 2, characterized in that: said preset information is created by specifying said category and then specifying said operation buttons belonging to said category.

6. The medical image capture apparatus as recited in any one of claim 2, characterized in that: said preset information is created for each type of examination.

7. The medical image capture apparatus as recited in any one of claim 2, characterized in that: said preset information is created for each operator.

8. The medical image capture apparatus as recited in any one of claim 2, characterized in that: said preset information is created for each imaging mode in ultrasonic imaging.

9. The medical image capture apparatus as recited in any one of claim 2, characterized in that: said preset information is created for each type of ultrasonic probe used in ultrasonic imaging.

10. The medical image capture apparatus as recited in any one of claim 1, characterized in that: those of said operation buttons that belong to the same category are arranged in one direction.

11. The medical image capture apparatus as recited in claim 10, characterized in that: operation buttons of different categories are arranged in a direction orthogonal to the direction of arrangement of said operation buttons belonging to the same category.

12. The medical image capture apparatus as recited in any one of claim 1, characterized in that: said operation buttons are soft keys.

13. The medical image capture apparatus as recited in any one of claim 1, characterized in that: said operation buttons are buttons selected by the operator during capture of a medical image.

14. The medical image capture apparatus as recited in any one of claim 1, characterized in that: said operation buttons are buttons for displaying a graphic symbol(s) or a character(s) in said medical image by being selected by the operator during capture of a medical image.

15. The medical image capture apparatus as recited in any one of claim 1, characterized in that: categories displayed in said one window are specified by the operator.

16. A medical image capture apparatus:
an operation button display section in which a plurality of operation buttons to be selected by an operator are displayed; and
an operation button display control section for displaying said plurality of operation buttons in said operation button display section, said control section displaying said plurality of operation buttons that each belong to one of a plurality of categories and are specified beforehand, in one window separately on a category-by-category basis.

17. A program for controlling a medical image capture apparatus, said program being characterized in causing a processor to execute: an operation button display control function of displaying a plurality of operation buttons in an operation button display section in which said plurality of operation buttons to be selected by an operator are displayed, said function displaying said plurality of operation buttons that each belong to one of a plurality of categories and are specified beforehand, in one window separately on a category-by-category basis.
